(19) United States
(12) Patent Application Publication
(10) Pub. No.: US 2005/0093491 A1
(43) Pub. Date: May 5, 2005

(54) Method for controlling a brushless electric motor

(76) Inventor: Bernd Kruger, Willich (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/924,760

(22) Filed: Aug. 24, 2004

(30) Foreign Application Priority Data
Aug. 25, 2003 (DE) 103 38 996.2

(51) Int. Cl. H02P 1/54; H02P 7/68

(52) U.S. Cl. 318/62

(57) ABSTRACT

The invention provides a method of controlling a brushless electric motor, in which the motor is driven in a starting speed range (A) from standstill up to a lower threshold speed (N₁) with an active control method and in an operating speed range (B) from the lower threshold speed (N₁) up to an upper threshold speed (Nk) with a passive control method. The invention further provides an electric drive, with an electric motor and with an electronic control unit, in which the electric motor is controlled in accordance with a method according to any of the preceding claims, and also an electrohydraulic power-assisted steering with a hydraulic pump which is driven by such an electric drive.

The invention relates to a method of controlling a brushless electric motor, and an electric drive comprising an electric motor and an electronic control unit which is suitable for carrying out such a method. The invention also relates to an electrohydraulic power-assisted steering comprising a hydraulic pump, which is driven by such an electric drive.

For the closed-loop control of brushless motors, the recognition of the rotor position is necessary. Hitherto, a rotor position indicator was used for this, e.g. a Hall sensor. The use of a position indicator, however, means additional effort in terms of components and installation with the costs connected therewith. In addition, the position indicator must if necessary be balanced at the final installation of the electric drive. Therefore, the requirement exists for a sensorless closed-loop control for brushless electric motors. From the prior art, various sensorless methods are known which, however, entail specific disadvantages.

There are passive methods, in which the rotor position is calculated from phase voltage and phase current with the aid of a control model with the motor parameters. Such methods are, however, not able to be used with sufficient stability and accuracy at a standstill or at very low speeds.

In other, active methods, test pulses are impressed during controlling, and from the response to these pulses, the instantaneous rotor position can be calculated and used for closed-loop control of the motor. This method is, however, connected with a noise development caused by the test pulses. Therefore, it is not suitable for use in motor vehicles. In addition, this type of motor controlling leads to a lower output efficiency and higher thermal losses.

The invention provides a method of controlling a brushless electric motor, in which the motor is driven in a starting speed range from standstill up to a lower threshold speed with an active control method, and in an operating speed range from the lower threshold speed up to an upper threshold speed with a passive control method. This method eliminates the disadvantages mentioned, because in the lower speed range and for starting the motor, the active method does not yet cause any intrusive noise development, whereas at higher speeds, advantageously the passive method can be used, which operates noiselessly.

According to an advantageous embodiment of the invention, in the active control method, the rotor position of the motor is determined by test pulses, by means of which the inductivity of the armature windings is established, and in the passive control method, the rotor position is determined from phase current and phase voltage.

According to a further aspect, the invention provides an electric drive, with an electric motor and an electronic control unit, in which the electric motor is controlled in accordance with a method according to any of the preceding claims. Such a drive can be produced at a particularly favorable cost, because a sensor for determining the rotor position and also its additional electronics for signal processing and voltage supply can be dispensed with. The accuracy of such a closed-loop control is at least equal to or better than the measurement of the rotor position by means of Hall sensors. In addition, dispensing with the position sensors saves structural space, so that the electric drive can be smaller, with the same output and measurement accuracy.

According to yet a further aspect, the invention provides an electrohydraulic power-assisted steering with a hydraulic pump which is driven by an electric drive of the type previously mentioned. Owing to its low noise development, such a power-assisted steering can be advantageously used in a motor vehicle, in particular in a passenger vehicle, where high traveling comfort is required.

The invention is described in further detail below with the aid of a preferred embodiment. Here, reference is made to the enclosed drawings, in which:

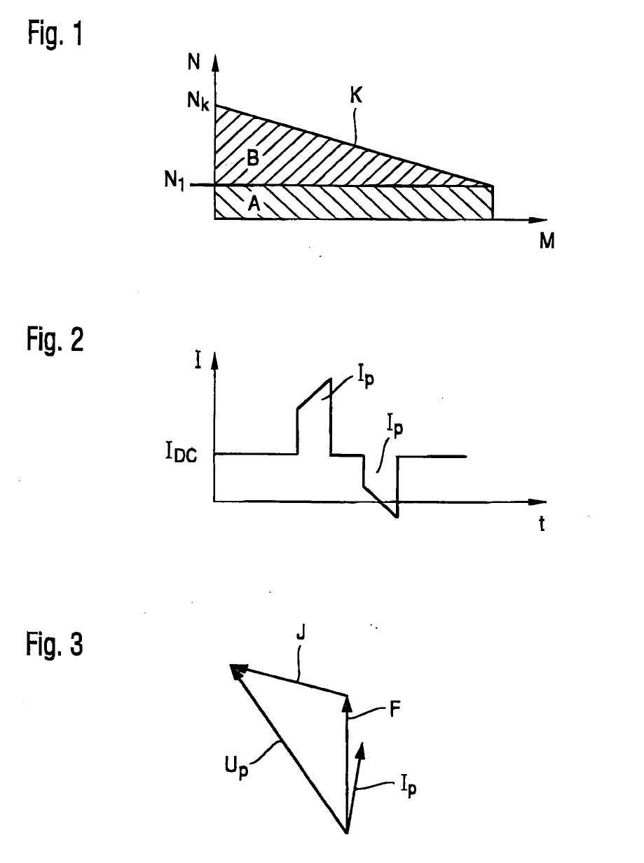

FIG. 1 shows a diagrammatic illustration of the motor characteristic with the use of the method according to the invention;

FIG. 2 shows a diagrammatic illustration of test pulses for the active method;

FIG. 3 shows a diagrammatic phase pointer diagram for the passive method.

FIG. 1 shows a schematic diagram, in which in the horizontal axis the torque M is entered, and in the vertical axis the speed N. By way of example, a typical motor characteristic K is entered, which shows the operating range of the electric motor between a lower threshold speed N₁ and an upper threshold speed Nₖ. For starting the motor, the latter is driven in a starting speed range A from standstill up to the lower threshold speed N₁ in a passive control method, in which the rotor position is determined by test pulses Ip, by means of which the inductivity of the armature windings of the motor, which is dependent on the instantaneous rotor position, is established. Here, the test pulses Ip are advantageously impressed as positive and negative pulses, as plotted in FIG. 2 in a current/time (I/t) diagram, so as not to generate additional torque. Even in a smooth-core electric motor, the saturation of the armature can be used to establish the rotor position. The saturation effect can advantageously be further intensified by a direct current I_{DC} being superimposed on the test pulses Ip. When driving the electric motor by pulse width modulation, the test pulses can also be integrated in the modulation pattern.

An alternative active control method, which is suitable for the method according to the invention, is provided by a so-called open-loop method, in which the motor is driven with an alternating phase current of a rising frequency from standstill up to the lower threshold speed N₁, whereby the rotor speed is forced to follow the frequency ramp. In an operating speed range B above the lower threshold speed N₁ up to its maximum speed Nₖ, the electric motor is driven with a passive control method, in which the rotor position is determined from the phase current and the phase voltage. For this, the electric motor parameters of stator resistance, inductivity and the return-emf constant must be known. Then the angle between the induced return-emf voltage and the terminal voltage U_{Kl} (or the phase current Iₚ) can be calculated from the phase current Iₚ and the terminal voltage U_{Kl}. This is illustrated diagrammatically in FIG. 3: The phase current Iₚ is measured directly or indirectly. This measurement is necessary for current monitoring in any case and therefore, compared with a conventional closed-loop motor control with a sensor, it does not require any additional circuitry expenditure in the control unit. The phase voltage Uₚ, illustrated by the thus designated vector arrow, is calculated from the terminal voltage U_{Kl} applied, which in turn can be determined for example from the pattern of the pulse width modulation, which is applied to an output end stage of the control unit. The amount of the vector J (instantaneous motor inductivity×2×π) and the amount of the vector F, which represents the return-emf, are known. Thereby, the angle between the vectors Uₚ and F can be calculated, which gives the instantaneous rotor position. Examples of such passive methods are known from the prior art under the names Luenberger Observer, Kalman Filter, and Sliding Mode Observer.

As the passive method is not performed in the normal operating speed range of the electric motor, sufficient computing power is available in the electronic control unit for calculating the rotor position as stated above.

The speed range of the motor can also be further divided into three or more speed ranges, in which the motor is driven by different methods which offer particular advantages in the corresponding speed ranges.

1. A method of controlling a brushless electric motor, in which the motor is driven in a starting speed range from standstill up to a lower threshold speed with an active control method and in an operating speed range from the lower threshold speed up to an upper threshold speed with a passive control method.

2. The method according to claim 1, wherein with the passive control method, the rotor position is determined from phase current and phase voltage.

3. The method according to claim 1 wherein with the active control method, the rotor position is determined by test pulses, by means of which the inductivity of the armature winding is established.

4. The method according to claim 1 wherein with the active control method, the motor is driven in an open-loop control method with an alternating voltage of rising frequency.

5. An electric drive comprising an electric motor and an electronic control unit, in which the electric motor is driven in a starting speed range from standstill up to a lower threshold speed with an active control method and in an operating speed range from the lower threshold speed up to an upper threshold speed with a passive control method.

6. An electrohydraulic power-assisted steering comprising a hydraulic pump; and,
an electric drive driving the hydraulic pump the electric drive comprising:
an electric motor; and
an electronic control unit controlling the electric motor such that the electric motor is driven in a starting speed range from standstill up to a lower threshold speed with an active control method and in an operating speed range from the lower threshold speed up to an upper threshold speed with a passive control method.
